(19) United States
(12) Patent Application Publication
(10) Pub. No.: US 2020/0256619 A1
(43) Pub. Date: Aug. 13, 2020

(54) SEPARATOR FOR SEPARATING A MIXTURE CONSISTING OF A SOLID MATERIAL AND A FLUID

(71) Applicant: NORDSON CORPORATION, WESTLAKE, OH (US)

(72) Inventors: Nikolai Schnellbach, Senden (DE); Dirk Schlief, Dulmen (DE); Kamal El Jouhari, Munster (DE)

(21) Appl. No.: 16/760,488

(22) PCT Filed: Nov. 2, 2018
(86) PCT No.: PCT/US2018/058973

§ 371 Date: Apr. 30, 2020

(30) Foreign Application Priority Data
Nov. 3, 2017 (EP) 17199847.9

(51) Int. Cl. F26B 5/08; F26B 17/22

(52) U.S. Cl. CPC F26B 5/08; F26B 17/22

(57) ABSTRACT

A separator has a housing that includes a screen positioned within the housing and defining a separation chamber having an inlet that receives a mixture and a discharge opening. The separator includes a pipe at least partially extending along an inlet axis, where the pipe is in fluid communication with the inlet of the separation chamber, and a rotor extending through the separation chamber, where the rotor rotates about a longitudinal axis such that rotation of the rotor moves the solid material upwards in a transport direction that is substantially parallel to longitudinal the axis. The inlet axis is oriented such that the pipe directs the material upwards through the inlet along a material direction that extends at least partially along the transport direction.

### CROSS REFERENCE TO RELATED APPLICATIONS

This application is a U.S. National Stage Application of International Patent Application No. PCT/US2018/058973, filed Nov. 2, 2018, which claims priority to European Patent Application No. 17199847.9, filed Nov. 3, 2017, the entire disclosures of both of which are hereby incorporated by reference as if set forth in their entireties herein.

### TECHNICAL FIELD

This disclosure generally relates to separators for separating a mixture into its fluid and solid material components. More particular, this disclosure relates to separators including a rotatable rotor positioned within a separating chamber.

### BACKGROUND

Conventional separators can be used for separating a mixture that consists, for example, of a solid material and a fluid into its respective constituents. The mixture of the solid material and the fluid is, in particular, supplied to the separator as a continuous conveying flow. The separators, which are also known as centrifugal dryers, are often used in the plastics processing industry. By means of such a separator, a plastic granulate can separated from a water stream conveying the granulate so that the granulate can be isolated for further processing or packaging.

Known separators have a housing with an inlet for supplying the mixture and at least one outlet for discharging the solid material and/or the fluid. Such separators include a separation chamber that comprises at least one inlet area for the mixture to be fed into and at least one discharge opening for emitting the separated solid material. The separation chamber is formed at least in regions by a screen configured to retain the solid material within the separation chamber and allow the fluid to pass through. Arranged within the separation chamber is a rotatably mounted rotor, which, by rotating, causes movement at least of the solid material with a direction of transport substantially along its longitudinal axis or axis of rotation.

The inlet area of the separation chamber, which may have a cylindrical shape, is usually formed on the surrounding wall of the separation chamber. The inlet area often has an incline that directs the material downwards towards the bottom of the separation chamber. Due to the potential energy present in the mixture, the mixture therefore automatically flows into the separation chamber. Because the rotating rotor is arranged in the separation chamber, the mixture experiences a deflection or reversal in movement in another direction upon entering the separation chamber. In particular, this deflection or reversal can cause the mixture to move upwards through the separation chamber. The solid material and at least parts of the fluid are then moved over a predetermined height along the longitudinal axis of the rotor.

The solid material to be separated from the mixture may under certain circumstances have abrasive properties and/or contain fillers, such as glass fibers or rock flour, which themselves have abrasive properties. Due to the deflection movement of the mixture following introduction into the separation chamber and the contact between the solid and the rotor, significantly greater wear may occur in the lower section of the rotor as compared to the upper sections. This wear necessitates maintenance of the separator at increasingly regular intervals, which causes corresponding downtimes of any upstream or downstream components of the separator within a plastics processing system.

As a result, there is a need for a separator that requires less downtime due to rotor wear caused by contact between the solid material of the mixture and the lower section of the rotor.

### SUMMARY

An embodiment of the present invention includes a separator for separating a mixture that comprises a solid material and a fluid. The separator has a housing having a mixture inlet for receiving a mixture, a first outlet for discharging the solid material, and a second outlet for discharging the fluid, where each of the solid material and the fluid is separated from the mixture at the first and second outlets, respectively. The separator also has a screen positioned within the housing, wherein the screen defines a separation chamber having an inlet configured to receive the mixture and a discharge opening configured to provide the solid material to the first outlet. Further, the separator has a pipe at least partially extending along an inlet axis, where the pipe is in fluid communication with the mixture inlet and the inlet of the separation chamber, and a rotor extending through the separation chamber, where the rotor is configured to rotate about a longitudinal axis such that rotation of the rotor is configured to move the solid material upwards from the inlet to the discharge opening in a transport direction that is substantially parallel to the longitudinal axis. The inlet axis is oriented such that the pipe is configured to direct the mixture upwards through the inlet along a material direction that extends at least partially along the transport direction.

### BRIEF DESCRIPTION OF THE DRAWINGS

The foregoing summary, as well as the following detailed description, will be better understood when read in conjunction with the appended drawings. The drawings show illustrative embodiments of the invention. It should be understood, however, that the application is not limited to the precise arrangements and instrumentalities shown.

FIG. 1 is perspective view of a separator according to an embodiment of the present disclosure;

FIG. 2 is a cross-sectional view of the separator shown in FIG. 1, taken along line 2-2 in FIG. 1;

FIG. 3 is a perspective view of an inlet area of the separator shown in FIG. 1;

FIG. 4 is a side view of the inlet area shown in FIG. 3, with the pipe arranged at different angles;

FIG. 5 is a cross-sectional view of an inlet area having a guide element according to another embodiment of the present disclosure;

FIG. 6 is a cross-sectional view of the inlet area shown in FIG. 5, with the guide element arranged at different angles;

FIG. 7 is a cross-sectional view of an inlet area have a plurality of guide elements according to another embodiment of the present disclosure;

FIG. 8 is a cross-sectional view of a separator having a rotor according to another embodiment of the present disclosure;

FIG. 9 is a perspective view of the inlet area shown in FIG. 3;

FIG. 10 is a top view of the inlet area shown in FIG. 9;

FIG. 11 is a perspective view of an inlet area according to another embodiment of the present disclosure;

FIG. 12 is a perspective view of an inlet area having a distribution chamber according to another embodiment of the present disclosure;

FIG. 13 is a perspective view of an inlet area having a distribution chamber according to another embodiment of the present disclosure;

FIG. 14 is a perspective view of an inlet area having a distribution chamber according to another embodiment of the present disclosure; and

FIG. 15 is a cross-sectional view of the inlet area shown in FIG. 14.

### DETAILED DESCRIPTION OF ILLUSTRATIVE EMBODIMENTS

Described herein is a separator 1 that includes a screen 16 defining a separation chamber 12. The separator 1 also includes a rotor 10 extending through the separation chamber 12 and a pipe 38 feeding material to the separation chamber 12 at an inlet 29, where at least a portion of the pipe 38 extends along an inlet axis 1A. Certain terminology is used to describe the separator 1 in the following description for convenience only and is not limiting. The words “right,” “left,” “lower,” and “upper” designate directions in the drawings to which reference is made. The words “inner” and “outer” refer to directions toward and away from, respectively, the geometric center of the description to describe the separator 1 and related parts thereof. The words “upwards” and “downwards” refer to directions in an axial direction A and a direction opposite the axial direction A along the separator 1 and related parts thereof. The terminology includes the above-listed words, derivatives thereof, and words of similar import.

Unless otherwise specified herein, the terms “axial” and “radial” are used to describe the orthogonal directional components of various components of the separator 1, as designated by the axial direction A and radial direction R. It should be appreciated that while the axial direction A is illustrated as extending along a vertical plane and the radial direction R is illustrated as extending along a horizontal plane, the planes that encompass the various directions may differ during use. Also, though the radial direction R may be shown as extending in a certain direction, the radial direction R may comprise any direction extending through a plane that is perpendicular to the axial direction A.

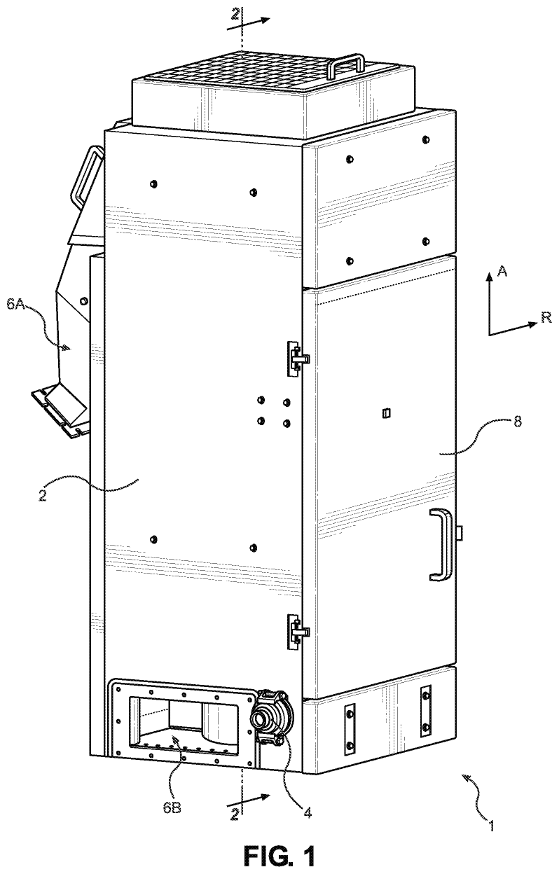

FIG. 1 shows a separator 1 that embodies a centrifugal dryer for separating a solid material from a mixture that also includes a fluid. The separator 1 comprises a housing 2 with a mixture inlet 4 for receiving a mixture consisting of a fluid, such as water, and a solid material, such as a plastic granulate. Though the fluid may be water and the solid material may be plastic granulate in one embodiment, the mixture components may comprise a variety of solids and liquids. Though the housing 2 is depicted as embodying a substantially rectangular prism, the housing 2 can other shapes as desired. The housing 2 has a first outlet 6a for discharging the solid material from the housing 2 and a second outlet 6b for discharging the solid material from the housing 2. At the first and second outlets 6a, 6b, each of the fluid and solid material, respectively, is separated from the mixture. Though the first and second outlets 6a, 6b are shown positioned at certain locations on the housing 2, each of the first and second outlets 6a, 6b can be positioned in alternative locations. A pivotably hinged housing door 8 can be arranged on the housing 2 to provide an operator with access to the interior of the separator 1. However, other devices allowing access to the interior of the housing 2 are contemplated.

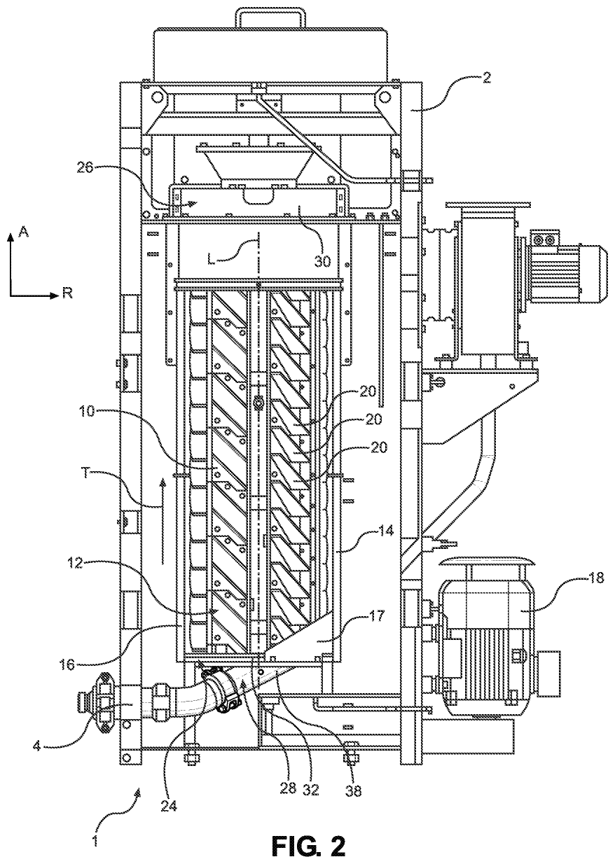

Now referring to FIG. 2, a rotor 10 is mounted within the housing 2. During operation of the separator 1, the rotor 10 is mounted along and configured to rotate about a longitudinal axis L that is substantially parallel to the axial direction A. Though the longitudinal axis L is depicted as extending substantially parallel to the axial direction A, the longitudinal axis L can alternatively be angularly offset from the axial direction A, such as by an angle of up to about 30 degrees. The separator 1 can also include a surrounding wall 14 that at least partially comprises a screen 16, where the screen 16 extends substantially circumferentially around the rotor 10 and defines a separation chamber 12 therein, where the separation chamber 12 extends from a lower end 24 to an upper end 26 opposite the lower end 24 along the axial direction A. As a result, the separation chamber 12 can have a cylindrical shape, and the rotor 10 can extend through the separation chamber 12. The screen 16 is configured to be fluid-permeable, such that the fluid of the mixture can pass through the screen 16, but the solid material of the mixture cannot. This enables the fluid to be separated from the solid material, as will be described further below.

The rotor 10 is preferably rotationally coupled to a drive 18. In one embodiment, the drive 18 is an electric motor, though other drives for rotating the rotor 10 are contemplated. The drive 18 can be controlled so as to adjust the rotational speed of the rotor 10 in relation to the flow of material entering the separation chamber 12. The rotor 10 includes a plurality of transport elements 20 extending radially outwards, where the transport elements 20 are arranged in several columns along the rotor 10. The columns of transport elements 20 extend along the axial direction A and are circumferentially spaced apart about the longitudinal axis L of the rotor 10. The transport elements 20, also referred to as lifting elements, are inclined and angularly offset with respect to the longitudinal axis L of the rotor 10. The body of each transport element 20 can be offset from the longitudinal axis L of the rotor 10 by an angle that can be from about 20 degrees to about 70 degrees. The body of each transport element 20 can also be at least partially curved and/or angled to cause a gradual or stepwise deflection of the solid material as it moves in the transport direction T, as will be described below. The outer surface of each transport element 20 can by contoured to match the contour of the inner surface of the screen 16. Though one particular arrangement of transport elements 20 and a particular number of transport elements 20 are shown, it is contemplated that the rotor 10 can include other arrangements and numbers of transport elements 20 in other embodiments. For example, the rotor can have four, five, six, or more columns of transport elements 20 uniformly distributed about the circumference of the rotor 10.

On the outer circumference of the rotor 10, the transport elements 20 form an outer conveying section in combination with the circumferentially surrounding screen 16 for moving the solid material through the separator 1. When the rotor 10 rotates about the longitudinal axis L, the transport elements 20 also rotate about the longitudinal axis L and are configured to move the solid material upwards in a direction of transport T that is substantially parallel to the longitudinal axis L. In the embodiment shown, the direction of transport T runs approximately along the axial direction A from the lower end 24 of the separation chamber 12 to the upper end 26 of the separation chamber 12. Extending outwards from the surrounding wall 14 and upwards from a base wall 32, a fluid-impermeable baffle surface 17 can be formed, which can deflect the mixture entering the separation chamber 12 at the lower end 24 in a circumferential direction. In operation, the solid is conveyed from an inlet area 28 at the lower end 24 of the separation chamber 12 towards a discharge opening 30 at the upper end 26 of the separation chamber 12 by the rotor 10 and associated transport elements 20. The discharge opening 30 is connected to the second outlet 6b for discharging the separated solid material. Simultaneously, a centrifugal force acting on the mixture in the radial direction R as the rotor 10 rotates will force the liquid radially outwards through the screen 16, and thus out of the separation chamber 12. This separation of the liquid from the solid material can occur over the entire height of the separation chamber 12, such that once the solid material reaches the upper end 26 of the separation chamber 12, it is completely separated from the liquid. Once the liquid passes radially outwards through the screen 16, it can fall downwards under the force of gravity and exit the separator 1 through the first outlet 6a.

Now referring to FIGS. 2-4, the inlet area 28 will be described in further detail. The inlet area 28 is formed at the lower end 24 of the separation chamber 12. As depicted, the inlet area 28 includes a base wall 32 that defines the lower side of the separation chamber 12. The separation chamber 12 has an inlet 29 that is defined by and extends through the base wall 32, where the inlet 29 is configured to receive the mixture from a pipe 38 that is configured to be connected to the base wall 32. The pipe 38 is positioned such that the mixture flows from the mixture inlet 4, through the pipe 38, and to the separation chamber 12 through the inlet 29 in such a way that, when the mixture enters the separation chamber 12, it moves along a material direction M that extends at least partially upwards along the axial direction A. A sealing member (not shown) can be positioned between the pipe 38 and the base wall 32 so as to prevent the mixture from leaking out of the pipe 38 and/or the separation chamber 12. The pipe 38 can be bonded to the base wall 32, or can be releasably attached to the base wall 32 such that the orientation of the pipe 38 can be adjusted. It is contemplated that the pipe 38 can comprise any conventional pipe or tube capable of direction a flow comprising a mixture of solid material and fluid.

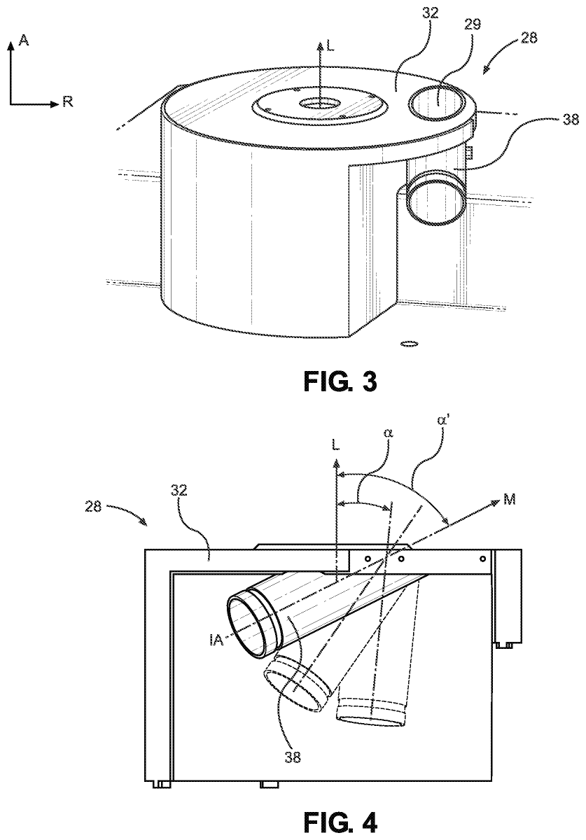

FIG. 3 shows a first embodiment of the inlet area 28. The pipe 38 is oriented relative to the separation chamber 12 in such a way that, upon entering or after entering the separation chamber 12, the mixture can perform a movement having an axial component, as well as a radial and/or tangential component. The mixture is, in particular, set into a spiral motion. Introducing the mixture to the separation chamber 12 via the base wall 32 has the advantage that the mixture can be fed into the separation chamber 12 in a preferred direction.

As FIG. 4 illustrates, the pipe 38 at least partially extends along an inlet axis IA. According to various embodiments of the separator according to the invention, various angles a, a′ ranging from 5° to 85° may be defined between the inlet axis IA of the pipe 38 and the longitudinal axis L of the rotor 10. However, the angles a, a′ are not to be construed as limited to this range, and can be from about 0° to about 90°. The pipe 38 may be immovably attached to the base wall 32 such that the inlet axis IA of the pipe 38 remains constant. However, in one embodiment, the pipe 38 is mounted within the housing 2 such that the pipe 38 is rotatable relative to the longitudinal axis L. In this embodiment, the pipe 38 can be rotated such that the angle defined between the inlet axis IA of the pipe 38 and the longitudinal axis L of the rotor 10 can be adjusted from the angle a to the angle a′. This adjustment can be performed due to a plurality of factors, such as rotational speed of the rotor 10, flow rate of the mixture through the pipe 38, characteristics of the solid and/or fluid comprising the mixture, etc. The inlet axis IA is oriented such that the pipe 38 is configured to direct the material upwards through the inlet 29 along the material direction M such that the material direction M is at least partially along the transport direction T. In other words, the inlet axis IA is oriented such that the material direction A defines a vector that comprises an upwardly extending axial component, where the magnitude of the axial component can change in accordance with the angle a. The smaller the angle a, the larger the magnitude of the axial component of the material direction M. As a result, the magnitude of the axial component of the material direction M can be adjusted by adjusting the orientation of the pipe 38, and thus the inlet axis IA.

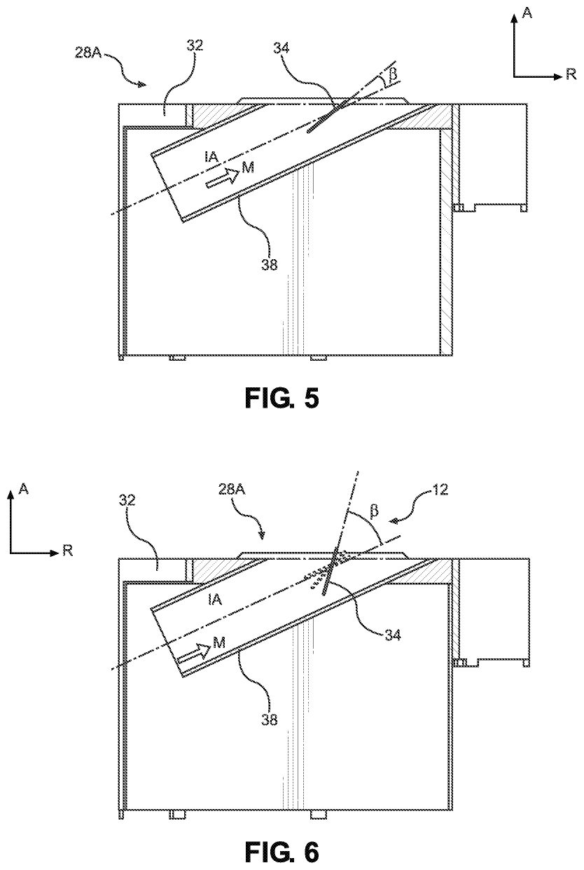

Now referring to FIGS. 5-7, other embodiments of an inlet section 28a-28b will be described. According to various embodiments, one or more guide elements 34 can be positioned at least partially within the pipe 38 such that they are capable of redirecting the material flowing through the pipe 38, and thus influencing the material direction M of the mixture as it flows through the inlet 29. Though depicted as comprising a substantially planar plate, the guide elements 34 can have alternative sizes and shapes as desired. An embodiment of an inlet section 28a having a single guide element 34 is shown in FIGS. 5-6. The guide element 34 can have an inclined orientation relative to the inlet axis IA. In particular, the guide element 34 is oriented at an angle β relative to the inlet axis IA such that the mixture, upon entering the separation chamber 12, moves at least partially in the transport direction T along a direction that has an axial component that is greater than that without the guide element 34. The angle of the material movement into the separation chamber 12 relative to the longitudinal axis L of the rotor 10 can thus be selected to be larger, and can be adjusted independent of the orientation of the pipe 38. This allows the space required for the inlet area 28 below the separation chamber 12 to be minimized, and can also allow for an increase in the velocity with which the material flows into the separation chamber 12. The angle β of the guide element 34 relative to the inlet axis IA and the pipe 38 can be fixed, or, as shown in FIG. 6, can be selectively adjusted through a variety of angular orientations relative to the inlet axis IA and the pipe 38. This adjustment can be performed due to a plurality of factors, such as rotational speed of the rotor 10, flow rate of the mixture through the pipe 38, characteristics of the solid and/or fluid comprising the mixture, etc.

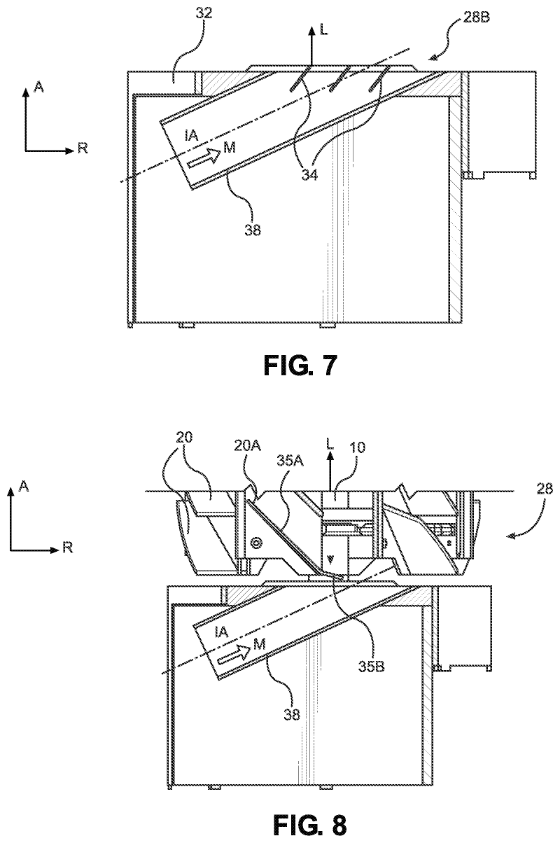

FIG. 7 depicts an alternative embodiment of an inlet section 28b that includes a plurality of guide elements 34. The plurality of guide elements 34 are shown as arranged as least partially within the pipe 38 along the radial direction R. Though the inlet section 28b is depicted as including three guide elements 34, the inlet section 28b can include more or less guide elements 34 as desired. Further, the guide elements 34 can have alternative relative positions and/or orientations. As the guide element 34 described above, the guide elements 34 of the inlet section 28b can be each individually fixed in a certain orientation relative to the inlet axis IA, or can be adjustably rotated relative to the inlet axis IA, either together or independently from each other.

Now referring to FIG. 8, in another embodiment, a lowermost transport element 20a on the rotor 10 can define a segmented body. In particular, each of the lowermost transport elements 20a can define a first planar portion 35a and a second planar portion 35b angularly offset from the first planar portion 35a. Compared to the other transport elements 20, the second planar portion 35b of the transport element 20a has a greater pitch angle relative to the longitudinal axis L of the rotor 10. With the second planar portion 35b being angled, a gentle reception of the solid materials fed into the separation chamber 12 via the inlet area 28 takes place. It is contemplated that in one embodiment, the angle of the second planar portion 35b relative to the first planar portion 35a can be adjusted.

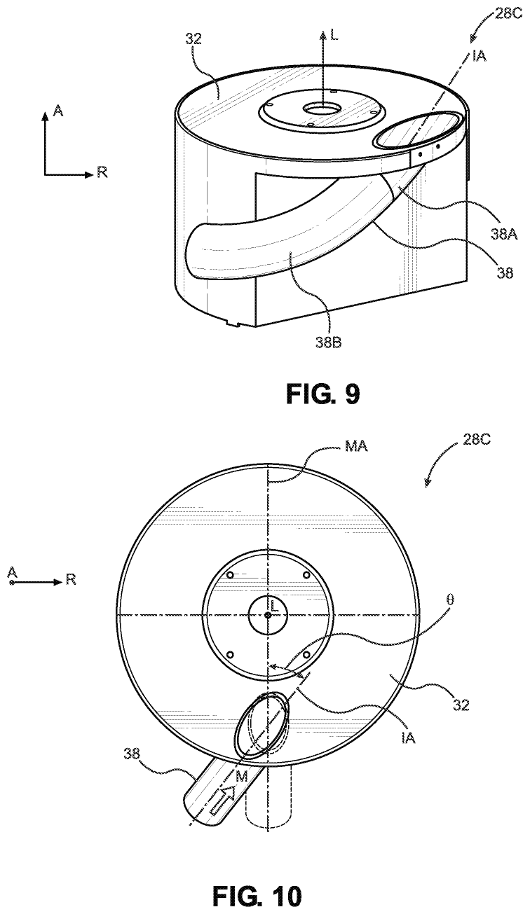

As can be seen in FIGS. 9-10 and in the previous figures, the inlet area 28 has a pipe 38, which, in the embodiment shown in FIG. 9, has at least a straight section 38a that defines a substantially linear length and a curved section 38b that defines a substantially curved length. FIG. 10 illustrates that the inlet axis IA in of the pipe 38 can be angularly offset with respect to a main axis MA that extends along the radial direction R and intersects the longitudinal axis L and the center of the inlet 29. In this embodiment, the inlet axis IA is oriented at an angle Θ of about 35° relative to the main axis MA. Thus, the mixture is fed through the inlet 29 into the separation chamber 12 along a material direction M having an axial, a tangential, and a radial component. The angle Θ between the inlet axis IA and the main axis MA may vary at an angle ranging from 0 to 90°. Depending upon the present embodiment of the separator 1 according to the invention, the inlet area 28 is designed so that its inlet axis IA is stationary or adjustable with respect to the main axis MA. Thus, in addition to adjusting the material direction M with respect to the longitudinal axis L of the rotor 10, whereby, primarily, the portion of the axial component of the material direction M is adjusted, a certain ratio between the tangential and the radial components of the material direction M can be adjusted upon inflow into the separation chamber 12 by adjusting the angle between the inlet axis IA and the main axis MA. Thus, the material direction M of the mixture fed into the separation chamber 12 can have a purely tangential component in addition to an axial component.

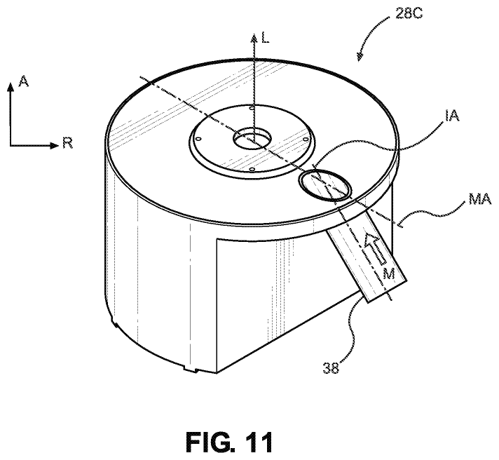

FIG. 11 shows another possible embodiment of an inlet area 28c, which has an inlet axis IA arranged at an angle in the range of about 0° with respect to a main axis MA The mixture fed into the separation chamber 12 thus, primarily, moves along a material direction M having an axial and a radial component.

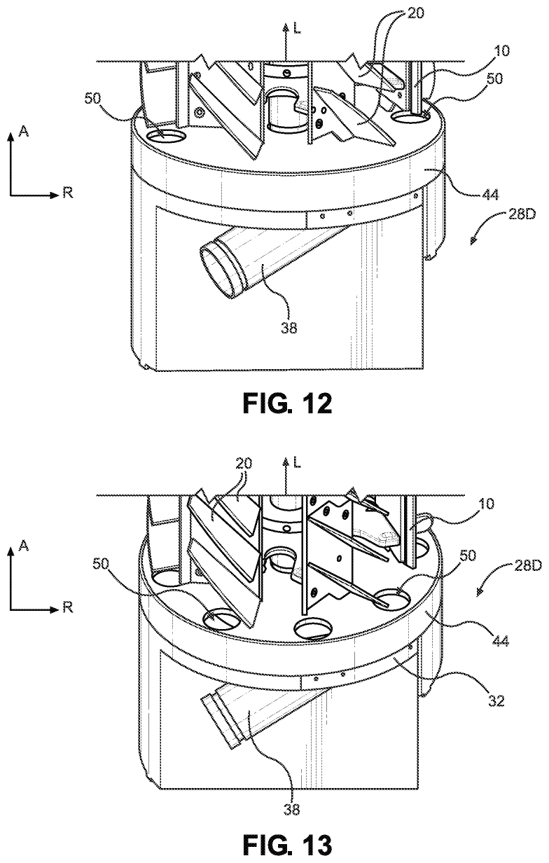

FIGS. 12 through 15 show alternative embodiments of a separator 1 according to the invention, wherein a distribution chamber 44 is provided in an inlet area 28d between the separation chamber 12 and the pipe 38. The distribution chamber 44 has at least one annular channel 48 (FIG. 15) arranged within the distribution chamber 44 for evenly distributing the mixture throughout the distribution chamber 44. As shown in FIGS. 12-13 the annular channel 48 can distribute the mixture from the mixture inlet 46 to several axially-oriented inlets 50. In FIG. 12, the base wall 32 defines two inlets 50 positioned on the base wall 32 radially opposite each other. In FIG. 13, the base wall 32 defines a plurality of inlets 50 spaced apart circumferentially about the longitudinal axis L. The inlets 50 shown in FIG. 13 are equidistantly spaced apart circumferentially about the longitudinal axis L so as to uniformly distribute the mixture through the inlets. However, it is contemplated that the spacing of the inlets 50 can differ in other embodiments.

A mixture to be separated within the separation chamber flows into the distribution chamber 44 via the pipe 38. The mixture is then distributed uniformly via the annular channel 48 in the distribution chamber 44 and then passes through the inlets 50 into the separation chamber 12. Depending upon the number of axial apertures, the apertures have cross-sections suitably adapted to the cross-section of the pipe 38. This prevents the mixture from piling up in the distribution chamber 44.

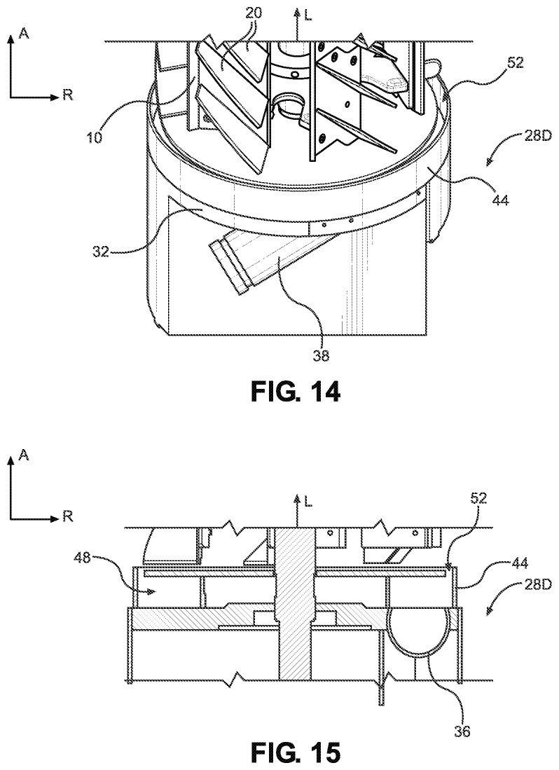

FIGS. 14 and 15 show an alternative embodiment of the inlet area 28d. In this embodiment, the base wall 32 defines an annular outflow slot 52 instead of inlets 50, where the outflow slot 52 extends from the distribution chamber 44 to the separation chamber 12. The outflow slot 52 is arranged in the vicinity of the cylindrical surrounding wall 14 of the separation chamber 12, though it is contemplated that the outflow slot 52 could be spaced inwardly from the surrounding wall 14. The width of the outflow slot 52 can be adapted to the grain size of the solid material, such as granulate, to be separated out of the mixture. The outflow slot 52 extends, in the embodiment shown, circumferentially about the longitudinal axis L along the entire circumference of the base wall 32 so as to uniformly distribute the mixture. However, the outflow slot 52 can extend only partially around the circumference of the base wall 32 in other embodiments. The outflow slot 52 can have a width ranging from about 5 mm to about 25 mm.

The separator 1 and constituent components described above achieve the underlying aim for a separator of separating a mixture consisting of a solid material and a fluid, which can be plastic granulate and water. In particular, the inlet areas 28a-28d and pipe 38 of the separator 1 are formed in such a way that, when the mixture enters the separation chamber 12, it performs a movement in the material direction M having at least one axial component relative to the longitudinal axis L of the rotor 10, where the material direction M extends at least partially in the transport direction T. These features help reduce the deflection of the mixture as it enters the separation chamber 12, and can preferably cause a deflection movement of the mixture to no longer take place. As a result, the wear upon features of the separator 1, in particular, the lower section of the rotor 10, is thus reduced to a minimum, even in the case of a separation process of a mixture containing solid material with abrasive properties from a fluid. The service life of the rotor 10 and other component parts and components which come into contact with the mixture and the solid to be separated therefrom can thus be lengthened, and the distances between possible maintenance intervals on the rotor can be increased.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts, and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features, and concepts may be expressly identified herein as being inventive or forming part of an invention, such identification is not intended to be exclusive, but rather there may be inventive aspects, concepts, and features that are fully described herein without being expressly identified as such or as part of a specific invention, the scope of the inventions instead being set forth in the appended claims or the claims of related or continuing applications. Descriptions of exemplary methods or processes are not limited to inclusion of all steps as being required in all cases, nor is the order that the steps are presented to be construed as required or necessary unless expressly so stated.

While the invention is described herein using a limited number of embodiments, these specific embodiments are not intended to limit the scope of the invention as otherwise described and claimed herein. The precise arrangement of various elements and order of the steps of articles and methods described herein are not to be considered limiting. For instance, although the steps of the methods are described with reference to sequential series of reference signs and progression of the blocks in the figures, the method can be implemented in a particular order as desired.

What is claimed:

1. A separator for separating a mixture that comprises a solid material and a fluid, the separator comprising:
a housing having a mixture inlet for receiving a mixture, a first outlet for discharging the solid material, and a second outlet for discharging the fluid, wherein each of the solid material and the fluid is separated from the mixture at the first and second outlets, respectively;
a screen positioned within the housing, wherein the screen defines a separation chamber having an inlet configured to receive the mixture and a discharge opening configured to provide the solid material to the first outlet;
a pipe at least partially extending along an inlet axis, wherein the pipe is in fluid communication with the mixture inlet and the inlet of the separation chamber; and
a rotor extending through the separation chamber, wherein the rotor is configured to rotate about a longitudinal axis such that rotation of the rotor is configured to move the solid material upwards from the inlet to the discharge opening in a transport direction that is substantially parallel to the longitudinal axis,
wherein the inlet axis is oriented such that the pipe is configured to direct the mixture upwards through the inlet along a material direction that extends at least partially along the transport direction.

2. The separator of claim 1, wherein the pipe is configured to direct the mixture through the inlet along a spiral trajectory having a radial and an axial component.

3. The separator of claim 1, wherein the pipe is adjustably mounted within the housing such that an angle between the inlet axis and the longitudinal axis is configured to be adjusted.

4. The separator of claim 1, further comprising:
one or more guide elements positioned within the pipe, wherein the one or more guide elements are configured to at least partially redirect the mixture flowing through the pipe.

5. The separator of claim 4, wherein the one or more guide elements are mounted within the pipe such that an orientation of the one or more guide elements is adjustable relative to the pipe.

6. The separator of claim 1, wherein an angle between the inlet axis and the longitudinal axis is between 0° and 90° .

7. The separator of claim 1, wherein the pipe comprises a straight section and a curved section.

8. The separator of claim 1, further comprising:
a base wall defining a lower end of the separation chamber,
wherein the inlet extends through the base wall.

9. The separator of claim 8, further comprising:
a distribution chamber positioned between the pipe and the base wall.

10. The separator of claim 9, wherein inlet comprises a plurality of inlets.

11. The separator of claim 10, wherein the plurality of inlets are equidistantly spaced apart circumferentially about the longitudinal axis.

12. The separator of claim 9, wherein the inlet is an annular channel extending circumferentially about the longitudinal axis.

13. The separator of claim 9, further comprising:
a fluid-impermeable baffle extending upwards from the base wall.

14. The separator according to claim 1, wherein the rotor includes a plurality of transport elements arranged in axially-extending columns about the longitudinal axis of the rotor.

15. The separator of claim 14, wherein at least one of the plurality of transport elements is angularly offset with respect to the longitudinal axis of the rotor.

16. The separator of claim 14, wherein at least one of the plurality of transport elements has a curved body.

17. The separator of claim 14, wherein at least one of the plurality of transport elements has a first planar portion and a second planar portion angularly offset from the first planar portion.

18. The separator of claim 1, wherein rotation of the rotor is configured to be adjusted in relation to a flow velocity of the mixture flowing through the pipe.

19. The separator of claim 1, further comprising:
a drive operatively connected to the rotor, wherein the drive is configured to rotate the rotor.

20. The separator of claim 1, wherein the solid material is plastic granulate and the fluid is water.
